(19) United States
(12) Patent Application Publication
(10) Pub. No.: US 2004/0178628 A1
(43) Pub. Date: Sep. 16, 2004

(54) Articulated joint for interconnecting two pipes for liquid

(76) Inventor: Jean-Yves Laubie, Neuilly-sur-Seine (FR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/474,561

(22) PCT Filed: Apr. 10, 2002
(86) PCT No.: PCT/FR02/01251

(30) Foreign Application Priority Data
Apr. 10, 2001 (FR) 01/04878

(51) Int. Cl. F16L 21/00

(52) U.S. Cl. 285/226

(57) ABSTRACT

The invention relates to an artic-ulated joint (1) which is designed to interconnect two discharge pipes for a liquid or gaseous fluid, comprising a sleeve (3) and a muff joint (7) which is received inside said sleeve (3). A rigid inner ring (9) is placed between the sleeve (3) and muff joint (7), and held in place by an elastic thrust organ such as a bellow (15) such that it rests against the sleeve (5). A rigid outer ring (17) is placed on the end of the female sleeve (3) and means (19) which are integral with the muff joint maintain the outer ring (17) in a position in which it is located in sliding contact, sliding against the end of said sleeve (3).

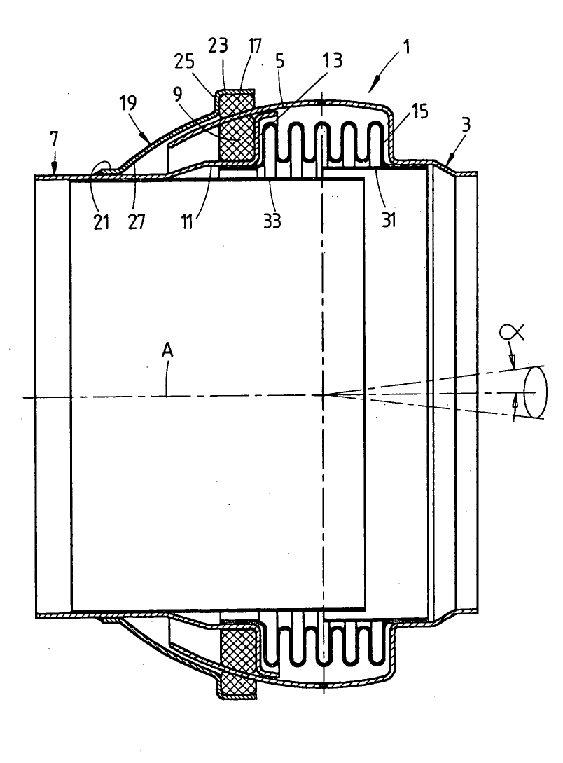

The present invention relates to an articulated joint designed, in particular, to interconnect two liquid or gas fluid flow pipes.

Joints of the above kind are used in fields such as aeronautical and automotive engineering when it is necessary to enable relative angular movement between two pipes during assembly or in service.

The document U.S. Pat. No. 5,967,565 discloses an articulated joint providing the above kind of connection and comprising:

a female sleeve having a substantially spherical end,

a male muff joint received in the female sleeve and having a shoulder in the vicinity of its end,

an inner ring threaded over said male muff joint, the exterior face of which is substantially spherical,

an elastic thrust member disposed between said female sleeve and said male muff joint to press said shoulder against said inner ring so that the exterior face of said inner ring is in sliding contact with the interior face of the substantially spherical end of said female sleeve, and

an outer ring threaded over the substantially spherical end of said female sleeve, the interior face of which is substantially spherical, and means fastened to said male muff joint to maintain said outer ring in a position in which its interior face is in sliding contact with the exterior face of the substantially spherical end of said female sleeve.

In the above prior art articulated joint, the inner and outer rings have in particular the function of damping vibrations transmitted from the female sleeve to the male muff joint (and vice-versa), and to this end are made from an elastic material.

Having two degrees of freedom, the above articulated joint can function correctly only if the shoulder of the male muff joint, the inner ring, the substantially spherical end of the female sleeve, the outer ring, and the retaining means fastened to the male muff joint are in positive contact, i.e. with no clearance.

Now, in the above prior art articulated joint, forces tending to move the female sleeve and the male muff joint axially or radially relative to each other are liable to break this positive contact, which can degrade the accuracy of the rotation movement of the female sleeve relative to the male muff joint and cause vibrations or shocks in operation, and even leakage from the articulated joint.

An object of the present invention is to remedy these disadvantages.

The above object of the invention is achieved by an articulated joint designed in particular to interconnect two liquid or gas fluid flow pipes, comprising:

a female sleeve having a substantially spherical end,

a male muff joint received in the female sleeve and having a shoulder in the vicinity of its end,

an inner ring threaded over said male muff joint, the exterior face of which is substantially spherical,

an elastic thrust member disposed between said female sleeve and said male muff joint to press said shoulder against said inner ring so that the exterior face of said inner ring is in sliding contact with the interior face of the substantially spherical end of said female sleeve, and

an outer ring threaded over the substantially spherical end of said female sleeve, the interior face of which is substantially spherical, and means fastened to said male muff joint to maintain said outer ring in a position in which its interior face is in sliding contact with the exterior face of the substantially spherical end of said female sleeve,

characterized in that said inner ring and said outer ring are made from a rigid material.

Thanks to their rigidity, the inner and outer rings cannot be compressed, which ensures that forces tending to move the female sleeve and the male muff joint axially or radially relative to each other will not break the abovementioned positive contact. This eliminates the abovementioned disadvantages.

According to other features of the articulated joint according to the invention:

said retaining means comprise an annular part having a first end fixed to said male muff joint and a second end defining a shoulder for retaining said outer ring in said position,

said annular part includes a substantially spherical intermediate portion complementary to the substantially spherical end of said female sleeve,

said elastic member bears freely at one end at least against said female sleeve or said male muff joint, without being fixed thereto, to allow axial rotation of said female sleeve or said male muff joint relative to said male muff joint or said female sleeve, respectively, and said elastic member,

said elastic member is chosen from the group comprising an elastic bellows, a coil spring, and an elastic washer,

said inner ring and/or said outer ring is made at least in part from metal covered with a deposit of a low-friction material chosen from the group comprising PTFE, graphite, and a ceramic,

said inner ring and/or said outer ring has a portion cooperating with one of said shoulders, made from a material chosen from the group comprising metal, graphite, and a ceramic, and a portion cooperating with the substantially spherical end of said female sleeve, made from a low-friction material such as PTFE,

said inner ring and/or said outer ring is made entirely from a material chosen from the group comprising metal, PTFE, graphite, and a ceramic,

said female sleeve and/or said male muff joint comprises a guide designed to encourage the flow of said fluid.

Other features and advantages of the present invention will become apparent on reading the following description and examining the accompanying drawing, in which the single FIGURE is a view in axial section of the articulated joint according to the invention.

All of the parts to be described hereinafter exhibit circular symmetry about the axis A of the joint (see the FIGURE).

The articulated joint 1 according to the invention comprises a female sleeve 3 having a substantially spherical end 5.

The female sleeve 3 receives a male muff joint 7 onto which is threaded an inner ring 9 whose exterior face, i.e. the face bearing against the substantially spherical end 5, is itself spherical.

The diameter of the exterior face of the inner ring 9 substantially corresponds to the diameter of the substantially spherical end 5.

The end 11 of the male muff joint 7 comprises a shoulder 13 in the form of a flange forming an abutment for the inner ring 9.

The inner ring 9 is preferably mounted loosely on the male muff joint 7, i.e. with a small radial clearance.

An elastic member 15 is disposed between the female sleeve 3 and the flange 13.

The elastic member can be an elastic metal bellows, for example, as shown in the figure, or (not shown) a coil spring or a spring washer.

As shown in the FIGURE, the whole of the portion of the female sleeve 3 that covers the elastic member 15 is preferably substantially spherical.

The articulated joint 1 further comprises an outer ring 17 threaded over the substantially spherical end 5 of the female sleeve 3 and whose interior face, i.e. the face in contact with the end 5, is itself substantially spherical.

The articulated joint 1 further comprises means for retaining the outer ring 17 in a position in which its interior face is in sliding contact with the exterior face of the substantially spherical end 5.

As shown in the figure, the aforementioned means can comprise an annular part 19 with a first end 21 which is fixed, for example welded, to the male muff joint 7, and whose other end 23 defines a shoulder 25 receiving the outer ring 17 in such a manner as to hold it in sliding contact with the exterior face of the substantially spherical end 5.

Between its ends 21 and 23, the annular part 19 includes a substantially spherical intermediate portion 27 complementary to the substantially spherical end 5 of the female sleeve 3.

The inner and outer rings 9, 17 are made from a rigid material.

In a first variant, the inner ring 9 and/or the outer ring 17 can be made at least in part from a metal covered with a low-friction material chosen from the group comprising polytetrafluroethylene (PTFE), graphite, and a ceramic.

In a second variant, the inner ring 9 and/or the outer ring 17 can comprise a portion cooperating with the shoulder 13 (respectively the shoulder 25) made from a material chosen from the group comprising metal, graphite, and a ceramic, and a portion cooperating with the substantially spherical end 5 of the female sleeve 3, made from a low-friction material such as PTFE.

In a third variant, the inner ring 9 and/or the outer ring 17 can be formed entirely from a material chosen from the group comprising metal, PTFE, graphite, and a ceramic.

The female sleeve 3 and/or the male muff joint 7 can optionally comprise a substantially cylindrical guide 31 (respectively 33) fixed coaxially to its interior.

The female sleeve 3, the male muff joint 7, the annular part 19, and the guides 31, 33 can be made from a metal alloy.

The substantially spherical end 5 of the female sleeve 3 can be welded to the remainder of the sleeve.

The advantages of the articulated joint according to the invention follow directly from the foregoing description.

Because of its geometry, and because the inner and outer rings 9, 17 can slide relative to the substantially spherical end 5 of the female sleeve 3, the articulated joint 1 enables relative angular movement a of the female sleeve 3 relative to the male muff joint 7.

The elastic member 15 disposed between the female sleeve 3 and the flange 13 firstly presses the flange against the inner ring 9 and secondly presses the exterior face of the inner ring into sliding contact with the interior face of the substantially spherical end 5 of the female sleeve 3.

This provides a good seal vis-à-vis the fluid that flows inside the articulated joint.

Because they are rigid, the inner and outer rings 9, 17 prevent forces tending to move the female sleeve 3 and the male muff joint 7 axially or radially relative to each other from breaking the positive contact established between the shoulder 13 of the male muff joint 7, the inner ring 9, the substantially spherical end 5 of the female sleeve 3, the outer ring 17, and the annular part 19.

This avoids any risk of degrading the accuracy of the rotation movement of the male muff joint relative to the female sleeve, vibrations and shocks in operation, and even leaks from the articulated joint.

Note further that, because the elastic member bears against both of them, the elastic member 15 elastically aligns the female sleeve 3 and the male muff joint 7.

When at least one end of the elastic member 15 is bearing freely against the female sleeve 3 or the male muff joint 7, without being fixed thereto, axial rotation of the female sleeve or the male muff joint relative to the elastic member and the male muff joint or the female sleeve, respectively, is allowed. Thus an articulated joint is obtained that has three degrees of freedom.

The use of guides 31, 33 in the joint according to the invention improves the flow of the fluid in the joint.

Moreover, the use of a low-friction material such as PTFE, graphite or a ceramic to form at least a portion of the inner and outer rings 9, 17 prevents binding of the joint according to the invention.

Note also that all of the portion of the female sleeve 3 that covers the elastic member 15 being substantially spherical allows greater relative angular movement of the female sleeve and the male muff joint relative to each other.

Of course, the present invention is not limited to the embodiment described and shown, which is provided by way of illustrative and non-limiting example.

1. An articulated joint (1) designed in particular to interconnect two liquid or gas fluid flow pipes, comprising:
a female sleeve (3) having a substantially spherical end (5),
a male muff joint (7) received in the female sleeve (3) and having a shoulder (13) in the vicinity of its end,
an inner ring (9) threaded over said male muff joint (7), the exterior face of which is substantially spherical, and
an elastic thrust member (15) disposed between said female sleeve (3) and said male muff joint (7) to press said shoulder (13) against said inner ring (9) so that the exterior face of said inner ring (9) is in sliding contact with the interior face of the substantially spherical end (5) of said female sleeve (3), and
an outer ring (17) threaded over the substantially spherical end (5) of said female sleeve (3), the interior face of which is substantially spherical, and means (19) fastened to said male muff joint (7) to maintain said outer ring (17) in a position in which its interior face is in sliding contact with the exterior face of the substantially spherical end (5) of said female sleeve (3),
characterized in that said inner ring (9) and said outer ring (17) are made from a rigid material.

2. An articulated joint (1) according to claim 1, characterized in that said retaining means comprise an annular part (19) having a first end (21) fixed to said male muff joint (7) and a second end (23) defining a shoulder (25) for retaining said outer ring (17) in said position.

3. An articulated joint (1) according to claim 2, characterized in that said annular part (19) includes a substantially spherical intermediate portion (27) complementary to the substantially spherical end (5) of said female sleeve (3).

4. An articulated joint (1) according to any one of the preceding claims, characterized in that said elastic member (15) bears freely at one end at least against said female sleeve (3) or said male muff joint (7), without being fixed thereto, to allow axial rotation of said female sleeve or said male muff joint relative to said male muff joint or said female sleeve, respectively, and said elastic member.

5. An articulated joint (1) according to any one of the preceding claims, characterized in that said elastic member (15) is chosen from the group comprising an elastic bellows, a coil spring, and an elastic washer.

6. An articulated joint (1) according to any one of the preceding claims, characterized in that said inner ring (9) and/or said outer ring (17) is made at least in part from metal covered with a deposit of a low-friction material chosen from the group comprising PTFE, graphite, and a ceramic.

7. An articulated joint (1) according to any one of the preceding claims, characterized in that said inner ring (9) and/or said outer ring (17) has a portion cooperating with one of said shoulders (13, 25), made from a material chosen from the group comprising metal, graphite, and a ceramic, and a portion cooperating with the substantially spherical end (5) of said female sleeve, made from a low-friction material such as PTFE.

8. An articulated joint (1) according to any one of the preceding claims, characterized in that said inner ring (9) and/or said outer ring (17) is made entirely from a material chosen from the group comprising metal, PTFE, graphite, and a ceramic.

9. An articulated joint (1) according to any one of the preceding claims, characterized in that said female sleeve (3) and/or said male muff joint (7) comprises a guide (31, 33) designed to encourage the flow of said fluid.
